(19) United States
(12) Patent Application Publication
(10) Pub. No.: US 2009/0042870 A1
(43) Pub. Date: Feb. 12, 2009

(54) Antimicrobial Composition

(76) Inventors: Adrian Fellows, West Yorks (GB); Guy Braverman, London (GB); Allen Hanouka, London (GB)

Correspondence Address: BASCH & NICKERSON LLP, 1777 PENFIELD ROAD, PENFIELD, NY, 14526, US

(21) Appl. No.: 11/908,899

(22) PCT Filed: Mar. 20, 2006
(86) PCT No.: PCT/GB2006/000984

§ 371 Date: Sep. 17, 2007

(30) Foreign Application Priority Data
Mar. 18, 2005 (GB) 0505634.6

(51) Int. Cl. A01N 47/44; A01N 33/12; A01N 37/52; A01N 43/40; A01N 43/84; A01N 43/42; A01N 47/34; C11D 3/48; A01P 1/00

(52) U.S. Cl. 514/224.8; 514/642; 514/635; 514/631; 514/311; 514/582; 510/131; 510/382; 510/391

(57) ABSTRACT

An antimicrobial composition suitable for cleaning inanimate surfaces and human skin comprises two or more cationic biocides and two or more biocides which are slower acting than the cationic biocides, wherein each cationic biocide is independently either:
(i) a quaternary ammonium compound at a concentration of at least 0.1% w/v; or
(ii) a biguanide compound.

The present invention relates to an antimicrobial composition and in particular to an antimicrobial composition for use on inanimate objects and surfaces as well as for the degerming of skin, of particular relevance in hospitals and other medical care establishments. It also relates to wipes impregnated with the antimicrobial composition.

Hospitals are by their nature occupied by people who are particularly susceptible to infections disease, because they themselves are ill and therefore have reduced immuno-response. The perception in recent years (in the UK at least) has been that a stay in hospital carries with it an ever-increasing risk of catching a bacterial infection. In particular, a great deal of press coverage has centred on the risk of catching MRSA, an acronym which relates to a collection of related methicillin-resistant (or multiple antibiotic-resistant) Staphylococcus aureus bacterial infections.

In order to minimize the risk of bacterial infection being passed on it is vital that a clean environment is maintained. Indeed, one theory links the rise in MRSA infection in UK hospitals with the out-sourcing of cleaning services to private companies and a consequent reduction in general hospital cleanliness. However, it is not just general cleanliness that should be maintained—many bacterial injections are transmitted by skin contact and personal cleanliness is therefore also important. In fact, to be safe, any surface that could have come into contact with a carrier and which might come into contact with a potential host should be kept clean. This includes not only a healthcare professional's skin (principally their hands) but also the patient's skin, stethoscopes, blood pressure cuffs, bed covers, etc.

Existing cleaning and disinfecting products include hand wet wipes, surface wet wipes and alcohol gel rubs. However, the latter can only be used on physically clean hands, which reduces their usefulness.

The more serious problem with existing cleaning products is that they are use-specific. In other words, there is a specific product for cleaning the doctor's hands and at least another for cleaning hospital surfaces. In fact there may be more than one product depending on the surface in question. The time taken to clean every surface is therefore increased by the need to identify the type of surface, select the appropriate cleaning product for that surface, and ensure that it and no other product is used to clean that surface. The result is that good practice in cleanliness is rarely adhered to because it simply takes too long.

There is therefore a need for a product which is not only feasible to use on tissue and inanimate surfaces, but is formulated to perform in a near optimum fashion on both types of surface.

U.S. Pat. No. 5,141,803 (Sterling Drug, Inc.) discloses an alcohol-free aqueous composition for impregnating a non-woven wipe for cleaning animate and inanimate surfaces. The composition has a pH of from 3.5 to 4.5 and contains a preservative system comprising potassium sorbate, citric acid, disodium EDTA and a cationic biocide. The objective of the invention is to eliminate ethyl alcohol from sorbic acid-citric acid-ethyl alcohol preservative systems whilst avoiding the “slippery feel” arising from the inclusion of cationic biocides, and the solution is to use a single specific cationic biocide, namely polyhexamethylene biguanide hydrochloride or poly[oxyethylene(dimethyliminio)ethylene(dimethyliminio)-ethylene dichloride]. The disclosed composition is a cleaning product which requires preservation against mould growth or other contamination, rather than a biocidal/disinfectant product.

Other antimicrobial compositions are disclosed in U.S. Pat. No. 5,141,803 (Sterling Drug, Inc.); U.S. Pat. No. 4,311,479 (Exterma-Germ Products Ltd); EP 0 231 080 (ICI PLC); and U.S. Pat. No. 5,670,160 (Schülke & Mayr GmbH).

EP 0 265 202 (Unilever NV) discloses a sanitizing composition comprising (i) one or more quaternary ammonium anti-microbial agents and/or one or more substituted guanidine anti-microbial agents; (ii) one or more organic acids; and (iii) one or more inorganic acids.

US 2001/0016589 (Modak et al.) discloses an antimicrobial composition comprising (i) between 0.025 and 2 percent of an antimicrobial agent selected form the group consisting of a chlorhexidine free base, a chlorhexidine salt, a polyhexamethylene biguanide and alexidine; (ii) between 0.005 and 0.1 percent of a quaternary ammonium compound; and (iii) between 0.025 and 2 percent of a chlorinated phenol compound. The problems with this composition are that (a) it employs a chlorinated phenol which is environmentally harmful and (b) it does not achieve a balance of components which enable it to be used on human skin and on inanimate surfaces to achieve adequate performance in a practically short contact time.

Accordingly, we provide a formulation which comprises rapid acting cationic biocides and which also provides residual slower acting preservative biocides along with ancillary chemicals.

In accordance with a first aspect of the present invention, there is provided an antimicrobial composition comprising two or more cationic biocides and two or more biocides which are slower acting than the cationic biocides.

Preferably, each cationic biocide is independently either:
(ii) a quaternary ammonium compound at a concentration of at least 0.1% w/v; or
(ii) a biguanide compound.

Preferably the slower acting biocides are preservative biocides.

A biocide is simply a substance which kills living things (including bacteria). A preservative biocide is a biocide which is commonly added to a product which is susceptible to microbial spoilage. Typically, the effect of such a biocide will be long lasting and slow acting and will include activity against fungi as well as bacteria. Preservative biocides are commonly included in an antimicrobial solution to prevent decay/deterioration of the solution and to increase its shelf life. It is a feature of this invention to add these to a formulation which does not require them as preservatives, but uses their properties in conjunction with last acting disinfectant biocides to give optimum performance over a wide range of use situations.

“Slower acting” means that the biocide takes longer to kill the same number of microorganisms than the biocide it is being compared to. The important feature is that there are a range of biocides which act at different rates in order to provide a broad spectrum of activity, to kill as many types of bacteria as possible and to reduce the likelihood of development of resistance. However, non-limiting representative rates of activity are as follows:
Cationic (disinfectant) biocides—from 30 seconds to 5 minutes
Slower acting biocides—from minutes to a few days or longer

The cationic (disinfectant) biocides preferably provide biocidal kills of at least 4 log reductions in the specified contact time while preservative biocides are preferably employed to prevent microbial growth from very small numbers of microbes.

Each cationic biocide may independently be a quaternary ammonium compound for example benzylalkonium chloride or Arquad (available from Sigma Aldrich), which is a mixture of dialkyldimethyl ammonium chlorides with the alkyl chain typically ranging from C₁₂-C₂₄. This component is preferably present in a concentration of at least 0.2% w/v, more preferably at least 0.3% w/v and most preferably from 0.33 to 0.57% w/v.

Alternatively or additionally, each cationic biocide may independently be a biguanide compound, for example polyhexamethylenebiguanide or chlorhexidine gluconate. This component is preferably present in a concentration from 0.075 to 0.125% w/v. most preferably about 0.1% w/v.

Further examples of cationic biocides are listed in U.S. Pat. No. 4,311,479 (Exterma-Germ Products Ltd), the contents of which are incorporated herein by reference. They include quaternary ammonium compounds such as alkyl dimethyl benzyl ammonium chlorides (e.g. alkyl dimethyl ethyl-benzyl ammonium chloride, and benzalkonium chloride), alkyl trimethyl ammonium bromides, cetyl pyridinium chlorides, or benzethonium chlorides. Suitable alkyl groups in such compounds contain predominantly straight chain C₁₂-C₁₈ groups. Bisguanide compounds are also listed, such as a soluble salt of 1,6-di-(4-chloro-phenyldisguanido hexane) or a polymeric bisguanide such as Vantocil®. In addition, amphoteric surfactants are provided such as dodecyl-di-(aminoethyl) glycine.

The slower acting preservative biocides may be chosen from amongst the many and varied chemicals which are known to those skilled in the art to be useful preservatives for cosmetics, drugs, foodstuffs or other products susceptible to microbial spoilage. For example, suitable biocides include Bronopol® (2-bromo 2nitropropane 1,3 diol); amidines including diamidines, propamidine, iodohexamidine; para hydroxy benzoate esters including methyl, propyl and butyl esters; 8 hydoxyquinoline; substituted benzyl alcohols; phenothiazines; and thiosemicarbazones. Preferred preservative biocides include alcohols such as aryloxyethanols and arylethanols. Particularly preferred are phenoxyethanol and phenylethanol.

If the composition includes an aryloxyethanol this is preferably present in a concentration from 0.037 to 0.063% w/v, most preferably about 0.05% w/v.

If the composition includes an arylethanol this is preferably present in a concentration from 0.015 to 0.025% w/v, most preferably about 0.02% w/v.

Other preservatives which may be present in the inventive composition comprise parahydroxybenzoate esters (so-called “parabens”), chlorbutol sorbic acid and citric acid.

The inventive composition is unique in its combination of components that not only deliver good antimicrobial performance (meeting the requirements of EN 1276 for surfaces and EN12054 and EN1500 for hands) but also comply with the safety requirements of the Cosmetic Products (Safety) Regulations 1996 and 2004.

The composition may also include a surfactant which may be a polyethylene oxide/polypropylene oxide block copolymer such as Surfac HT20 (available from Surfachem ltd). This component may be present in a concentration from 0.0075 to 0.0125% w/v, preferably about 0.01% w/v.

In addition to the biocides mentioned above, the composition may also comprise a compound which acts as a biocide (and preferably a preservative) in the vapour phase. This serves to disinfect the interior of a container in which the composition is stored. An example of such a biocide is 2,4-dichlorobenzyl alcohol. It may be present in a concentration from 0.015 to 0.025% w/v, most preferably about 0.02% w/v.

The composition preferably includes a chelating agent (such as EDTA) in a concentration from 0.0075 to 0.0125% w/v, preferably about 0.01% w/v.

An emollient (such as propyleneglycol) may be provided to aid use of the composition on skin. More complex emollient and skin conditioning components may be added such as Aloe vera or vitamin E. The emollient is preferably included in a concentration from 0.75 to 1.25% w/v, most preferably about 1% w/v.

Alcohol (most commonly ethanol) may also be added to the composition in a concentration from 3.75 to 6.25% w/v, most preferably about 5% w/v. This acts as an evaporative solvent.

The composition may further comprise a variety of additives such as thickeners, dyes, moisturizers and perfumes the identity of which would be well known in the technical field.

The balance of the composition is preferably water.

The composition may be formulated as a solution, gel, mousse or spray as required.

In a preferred embodiment, the composition is substantially free of chlorinated phenol.

In accordance with a second aspect of the present invention, there is provided material, preferably nonwoven, (such as a thermo-bonded 35 gsm non-woven wipe) impregnated with the antimicrobial composition as defined above.

The impregnation may take place by one of a variety of methods, namely by padding and squeezing, spraying or coating, soaking and squeezing or application of a measured dose and squeezing or wicking to result in uniform impregnation.

In accordance with a third aspect of the present invention, there is provided he use of a composition or of impregnated material as defined above to clean human skin, an inanimate surface, or both.

### EXAMPLE

A preferred composition in accordance with the invention was formulated by combining the components listed in Table 1 below as a simple solution of ingredients at room temperature:

TABLE 1

| | Concentration | |
|---|---|---|
| Component | (% w/v) | Description |
| Benzalkonium chloride, Alkyl | 0.45 | Quaternary ammonium biocide |
| dimethylbenzyl ammonium | | |
| chloride | | |
| Arquad Di chain quat | 0.40 | Quaternary ammonium biocide |
| Polyhexamethylenebiguanide | 0.1 | Biocide |
| Surfac HT20 | 0.01 | Polyethylene oxide/poly propylene oxide |
| | | block copolymer surfactant |
| Phenoxyethanol | 0.05 | Slow acting preservative biocide |
| 2,4-dichlorobenzyl alcohol | 0.02 | Biocide and vapour phase preservative |
| EDTA di Na | 0.01 | Chelating agent |
| Phenylethanol | 0.02 | Slow acting preservative biocide |
| Mono-propylene glycol | 1.00 | Emollient |
| Alcohol (denatured) | 5.00 | Evaporative solvent |
| Water | Balance | Solvent |

A thermo-bonded 35 gsm non-woven wipe was then impregnated with the composition by soaking and squeezing the wipe to allow uniform impregnation.

The above-identified Example composition (hereinafter referred to as “the Composition”) was subjected to the following tests:

TEST 1
Bactericidal activity of the Composition for post contamination
treatment of hands determined using the British/European Standard
Test method BS EN 12054:1995

| | |
|---|---|
| Tests Carried Out By: | School of Applied Sciences, Queensgate. |
| University of | Huddersfield HD1 3DH |
| Huddersfield | |
| Test Method | British/European Standard BS EN 12054:1995 |
| Test Procedures | Full details of all the test and control procedures |
| | used are given in the Test Method |
| Batch Tested | 17012005 |
| Temperature | 20° C. (± 1° C.) |
| Contact Time Tested | 1 minute |
| Test Organisms | Escherichia coli 8879 (NCIMB). Enterococcus |
| | hirae 8192 (NCIMB), Pseudomonas aeruginosa |
| | 10421 (NCIMB), Staphylococcus aureus 9518 |
| | (NCIMB) National Collections of Industrial, |
| | Food and Marine Bacteria, Aberdeen. |
| Culture Medium | Tryptone Soya Agar, LabM |
| Incubation | Plates were incubated at 37° C. for 24-48 h |
| Counting procedure | Pour plate |
| Diluent | Tryptone Sodium Chloride Solution |
| Neutraliser | “Universal” neutraliser containing polysorbate |
| | 80, L-histidine, lecithin and sodium thiosulphate |
| | in diluent. Tests were carried out to verify that |
| | this neutraliser was satisfactory (see validation |
| | results Tables 2 and 3). |

### General Method

A standard suspension of test organisms containing 1.5-5.0×10⁸ cells ml⁻¹ of bacteria was prepared. 9 ml of the Composition was pipetted into a sterile Universal bottle. 1 ml of test organism suspension was added, mixed and left for a contact time of 1 min±5 s in a temperature controlled water bath (20° C.±1° C.). At the contact time 1 ml of the mixture was pipetted into a tube containing 8 ml of neutraliser and 1.0 ml of water. After a neutralisation time of 1 min±5 s a series of ten-fold dilutions (to 10⁻³) was prepared in the diluent. 1 ml samples in duplicate of the 10⁰ (undiluted neutralised sample), 10⁻² and 10⁻³ dilutions of neutralised mixture was inoculated into sterile Petri dishes and mixed with 15 ml of culture medium tempered at 47° C. After setting the Petri dishes were incubated at 37° C. Colony forming units were counted after 48 h incubation and the fraction of surviving organisms calculated.

### Results

TABLE 2
Bactericidal activity of the Composition

| | Contact | Colony Counts per plate |
|---|---|---|
| Test Organism | Time (min) | cfu ml⁻¹ |
| Escherichia coli | 1 | <3 × 10^{2*} |
| Enterococcus hirae | 1 | <3 × 10^{2*} |
| Pseudomonas aeruginosa | 1 | <3 × 10^{2*} |
| Staphylococcus aureus | 1 | <3 × 10^{2*} |

*No visible bacterial growth on any plate; 10⁰, 10⁻², 10⁻³)

### Summary and Conclusion

Tests were carried out according to BS EN 12054:1995

### Requirements of This Standard

Hygienic handrub products which demonstrate a reduction in viable counts from 1×10⁷ to 3×10⁷ cfu ml⁻¹ to no more than 3×10² cfu ml⁻² within 1 min at 20° C. when the test organisms are Escherichia coli, Enterococcus hirae, Pseudomonas aeruginosa, Staphylococcus aureus are deemed to have passed the test.

### Interpretation of the Results

The Composition passed the test and can be described as a bactericidal preparation for hygienic hand disinfection.

### Method Validation

### A1. Validation of Non-Toxicity of the Neutralisation Medium (Control)

To 9 ml of neutralisation medium 1 ml of bacterial test suspension diluted to 1×10³ to 3×10³ is added, mixed and left in the water bath at 20° C.±1° C. for a contact time of 1 mm±5 s. At the end of the contact time 1 ml samples are taken in duplicate and pour plates prepared, after incubation at 37° C. for 48 h. The average plate count N′ of the neutralisation medium is determined.

### A2. Validation of the Inactivation by the Dilution Neutralisation Method (Test)

To 1 ml of the bacterial diluent 9 ml of the handrub product is added, mixed and left in a water bath at 20° C.±1° C. for 5 min±10 s. 1 ml of the mixture is then transferred to 8 ml of neutralising medium, maintained at 20° C.±1° C. and left for 5 min±10 s. 1 ml of bacterial test suspension diluted to 1×10³ to 3×10³ is added, mixed and left for a contact time of 1 min±5 s. At the end of the contact time 1 ml samples are taken in duplicate and pour plates prepared, after incubation at 37° C. for 48 h. The average plate count n′ of the dilution neutralisation method is determined.

TABLE 3
Validation of dilution-neutralisation method

| | | Validation | |
|---|---|---|---|
| | Bacterial test | of neutralisation | |
| Test Organism | suspension (cfu ml⁻¹) | A1, Control | A2, Test |
| Escherichia coli | 117, 108 | 105, 99 | 89, 96 |
| | (N = 113) | (N′ = 102) | (n′ = 93) |
| Enterococcus hirae | 250, 244 | 236, 252 | 225, 215 |
| | (N = 247) | (N′ = 244) | (n′ = 220) |
| Pseudomonas | 165, 166 | 155, 153 | 150, 155 |
| aeruginosa | (N = 166) | (N′ = 154) | (n′ = 153) |
| Staphylococcus aureus | 127, 111 | 96, 83 | 88, 79 |
| | (N = 119) | (N′ = 90) | (n′ = 84) |

### Results

For the strains tested:
N and N′ are between 100 and 300 cfu
N′ is greater than 0.5 times N
n′ is greater than 0.5 times N′

The neutralisation is validated with the neutralisation medium tested.

TEST 2
Bactericidal activity of the Composition determined using the
British/European Standard Test method BS EN 1276:1997 against:
Escherichia coli 8879 (NCIMB): Enterococcus hirae 8191
(NCIMB): Pseudomonas aeruginosa 10421 (NCIMB) and
methicillin-resistant Staphylococcus aureus (MRSA) (Oxoid)

| | |
|---|---|
| Tests Carried Out By: | Queensgate, Huddersfield HD1 3DH |
| University of | |
| Huddersfield | |
| Test Method | British/European Standard BS EN 1276:1997 |
| Test Procedures | Full details of all the test and control procedures |
| | used are given in the Test Method |
| Interfering Substance | 1. Simulated clean conditions: |
| (Organic Challenge) | 0.3 g l⁻¹ bovine albumin (final |
| | concentration) |
| | 2. Simulated dirty conditions: |
| | 3.0 g l⁻¹ bovine albumin (final |
| | concentration) |
| Temperature | 20° C. (± 1° C.) |
| Contact Time Tested | 1 (± 10 s) minutes |
| Test Organisms | Escherichia coli 8879 (NCIMB): Enterococcus |
| | hirae 8191 (NCIMB); Pseudomonas aeruginosa |
| | 10421 (NCIMB) and methicillin-resistant |
| | Staphylococcus aureus (MRSA) (Oxoid) |
| Culture Medium | Tryptone Soya Agar, LabM |
| Incubation | Plates were incubated at 37° C. for 24-48 h |
| Diluent | Tryptone Sodium Chloride Solution |
| Neutraliser | “Universal” neutraliser containing polysorbate |
| | 80, L-histidine, lecithin and sodium thiosulphate |
| | in diluent. Tests were carried out to verify that |
| | this neutraliser was satisfactory. |

### General Method

A standard suspension of test organisms containing 1.5-5.0×10⁸ cells ml⁻¹ of bacteria was prepared. 1 ml of interfering substance was pipetted into a Universal bottle. 1 ml of test organism suspension was added, mixed and left for 2 minutes. 8ml of disinfectant was then added aid mixed. After contact time of 1 minute, a 1 ml sample of the reaction mixture was pipetted into 9 ml of neutraliser and left for 5 minutes. A 1 ml sample was pipetted into 2 Petri dishes and mixed with 15 ml of culture medium tempered at 47° C. After setting the Petri dishes were incubated at 37° C. Colony forming units were counted after 1-2 days incubation and the fraction of surviving organisms calculated.

TABLE 4
Results

| | | Log₁₀ Reduction |
|---|---|---|
| Serum concn. | Contact Time (minutes) | Achieved |
| 0.3 g l⁻¹ (clean) | 1 | >5¹ |
| 3.0 g l⁻¹ (dirty) | 1 | >5¹ |

¹See full results in Table 5 below

### Summary and Conclusion

Tests were carried out according to BS EN 1276:1997

### Requirements of This Standard

The Composition, when tested as stipulated under simulated clean conditions (0.3 g l⁻¹ bovine albumin) or dirty conditions (3 g l⁻¹ bovine albumin) under the required test conditions (20° C., 1 minute contact, for selected reference strains), shall demonstrate at least a 5 log₁₀ reduction in viable counts.

Interpretation of the Results

The Composition tested against Escherichia coli 8879 (NCIMB); Enterococcus hirae 8191 (NCIMB); Pseudomonas aeruginosa 10421 (NCIMB) and methicillin-resistant Staphylococcus aureus (MRSA) (Oxoid) for a contact time of 1 minutes at 20° C., under simulated clean and dirty conditions, met the requirements of this Standard.

TABLE 5
Test results EN 1276:1997

| | | Final conc. | |
|---|---|---|---|
| | | (CFU ml⁻¹) | Final conc. |
| | Starting | clean 0.3 g l⁻¹ | (CFU ml⁻¹) dirty |
| | conc. | Albumin | 3.0 g l⁻¹ Albumin |
| Referenced Organism | (CFU ml⁻¹) | bovine | bovine |
| Escherichia coli 8879 | 1.54 × 10⁸ | 0, 0. Actual 8 | 0, 0. Actual 8 |
| (NCIMB | (141, 166)¹ | log₁₀ reduction | log₁₀ reduction |
| Enterococcus hirae | 1.89 × 10⁸ | 0, 0. Actual 8 | 0, 0. Actual 8 |
| 8191 | | | |
| (NCIMB) | (189, 189)² | log₁₀ reduction | log₁₀ reduction |
| Pseudomonas | 1.50 × 10⁸ | 0, 0. Actual 8 | 0, 0. Actual 8 |
| aeruginosa 10421 | (144, 156)³ | log₁₀ reduction | log₁₀ reduction |
| (NCIMB) | | | |
| methicillin-resistant | 7.6 × 10⁸ | 0, 0. Actual 8 | 0, 0. Actual 8 |
| Staphylococcus aureus | (79, 73)⁴ | log₁₀ reduction | log₁₀ reduction |
| (MRSA) (Oxoid) | | | |

CFU ml⁻¹ colony forming units (viable count of bacterial colonies, 1 ml sample)
¹Mean of 10⁻⁶ dilution
²Mean of 10⁻⁶ dilution
³Mean of 10⁻⁶ dilution
⁴Mean of 10⁻⁷ dilution

TEST 3
Bactericidal activity of the Composition determined using the European
Standard Test method BS EN 1276:1997 (modified) against:
Mycobacterium smegmatis (NCIMB 133116)

| | |
|---|---|
| Tests Carried Out By: | University of Huddersfield, School of Applied |
| | Sciences, Queensgate, Huddersfield HD1 3DH |
| Date: | November 2005 |
| Microbiological Tests | |
| Test Method | British/European Standard BS EN 1276:1997 |
| | (modified). Dilution-neutralisation |
| Test Procedures | Full details of all the test and control procedures |
| | used are given in the Test Method |
| Interfering Substance | 1. Simulated clean conditions: |
| (Organic Challenge) | 0.3 g l⁻¹ bovine albumin (final |
| | concentration) |
| | 2. Simulated dirty conditions: |
| | 3.0 g l⁻¹ bovine albumin (final |
| | concentration) |
| Temperature | 20° C. (± 1° C.) |
| Contact Time Tested | 5 (± 10 s) minute. |
| Test Organisms | Mycobacterium smegmatis (NCIMB 133116) |
| Culture Medium | Nutrient Agar, Lab M |
| Incubation | Plates were incubated at 37° C. for 24-48 h |
| Diluent | Tryptone Sodium Chloride Solution |
| Neutraliser | “Universal” neutraliser, containing polysorbate |
| | 80, L-histidine, lecithin, saponin and sodium |
| | thiosulphate in diluent. Tests were carried out to |
| | verify that this neutraliser was satisfactory. |

### General Method

A standard suspension of test organisms containing 1.5-5.0×10⁸ cells ml⁻¹ of bacteria was prepared, 1 ml of interfering substance was pipetted into a Universal bottle, followed by 1 ml of test organism suspension. The mixture was mixed and left for 2 minutes. After 2 minutes 8 ml of disinfectant was added and mixed. In this case the disinfectant was a 50% dilution of the handrub. After a contact time of 5 minutes, a 1 ml sample of the reaction mixture was pipetted into 9 ml of neutraliser and left for 5 minutes. A 1 ml sample was then pipetted into 2 Petri dishes and mixed with 1.5 ml of culture medium tempered at 47° C. After setting, the Petri dishes were incubated at 37° C. Colony forming units were counted after 1-2 days incubation and the fraction of surviving organisms calculated

Modifications to BS EN 1276:1997

Tests were carried out according to a modified version of BS EN 1276:1997. These modifications were that a 50% dilution of the test material was used, M. smegmatis was the test organism and nutrient agar was employed as growth medium. A 50% dilution of the test material was necessary in order to ensure an accurate contact time. It was not possible to produce an accurate contact time with the full strength product due to incomplete neutralisation.

Requirements of This Standard

The product, when tested as stipulated under simulated clean conditions (0.3 g l⁻¹bovine albumin) or dirty conditions (3 g l⁻¹ bovine albumin) under the required test conditions (20° C., 5 minute contact, for the selected reference strain ), shall demonstrate at least a 5 log₁₀ reduction in viable counts.

### Results

Results from the test are summarised in Tables 6 and 7, a full set of results can be found in Table 8.

TABLE 6
Log₁₀ reductions in M. smegmatis viable counts following a 5 minute
exposure to a 50% dilution of the test material.

| | | Log₁₀ Reduction |
|---|---|---|
| Test Conditions | Contact Time (minutes) | Achieved |
| 0.3 g l⁻¹ (clean) | 5 | >5¹ |
| 3.0 g l⁻¹ (dirty) | 5 | >5¹ |

TABLE 7
Reductions in M. smegmatis viable counts following a 5 minute exposure
to a 50% dilution of the test material.

| | | Final | Final |
|---|---|---|---|
| | | concentration | concentration |
| | Starting | CFU ml⁻¹ clean | CFU ml⁻¹ dirty |
| Referenced | concentration | 0.3 g l⁻¹ Bovine | 3.0 g l⁻¹ Bovine |
| Organism | CFU ml⁻¹ | Albumin | Albumin |
| Mycobacterium | 3.2 × 10⁸ | Plate count 0, 0. | Plate count 0, 0. |
| smegmatis | (340, 300)¹ | (Actual 8 log₁₀ | (Actual 8 log₁₀ |
| (NCIMB 133116) | | reduction) | reduction) |

CFU = colony forming units
¹viable count of bacterial colonies, 1 ml sample of 10⁻⁶ bacterial suspension

### Interpretation of the Results

When tested against Mycobacterium smegmatis (NCIMB 133116) with a 5 minute contact time a 50% dilution of the handrub met the requirements of the Standard under simulated clean and dirty conditions.

### Conclusion

According to EN 1276:1997, the Composition when diluted at 50% (V/V) in hard water, possesses bactericidal activity in 5 minutes at 20° C. under clean conditions (0.3 g/l bovine albumin) and dirty conditions (3 g/l bovine albumin) for referenced strain Mycobacterium smegmatis.

TABLE 8
Testing of Mycobacteria smegmatis (NCIMB 133116) against a 50%
dilution of the Composition using a modified version of BS EN 1276:1997.

| | | | | | | Test Procedure at |
|---|---|---|---|---|---|---|
| | | | | | | Concentration |
| Test | | | | | Bacterial Test | % (V/V) |
| Organism | Validation Test | | | | Suspension | 50% solution biocide |
| Mycobacterium | V_{c} 340; 300 | V_{c} 183; 176 | V_{c} 317, 329 | V_{c} 120; 209 | 10⁻⁶: 340, 300 | V_{c} > 300, 300 |
| Smegmatis | Nv: 3.2 × 10³ | A · 3.2 × 10³ | A · 3.2 × 10³ | A · 3.2 × 10³ | 10⁻⁷: 31, 26 | Nₐ > 3 × 10³ |
| Clean | | | | | 3.2 × 10³ | R > 10 [symbol] (≧ 10⁸) |
| Mycobacteria | V_{c} 340; 300 | V_{c} 278; 264 | V_{c} 317; 329 | V_{c} 131; 160 | 10⁻ [symbol] : 340, 300 | |
| Smegmatis | Nv: 3.2 × 10³ | A · 3.2 × 10³ | A · 3.2 × 10³ | A · 3.2 × 10³ | 10⁻ [symbol] : 31, 26 | |
| Dirty | | | | | 3.2 × 10³ | |

Vc = Viable Count
N = Number of cfu/ml of bacterial test suspension.
Nv = Number of cfu/ml of bacterial suspension.
R = Reduction in viability.
Na = Number of cfu/ml in the test mixture.
A = Number of cfu/ml of the experimental conditions validation.
B = Number of cfu/ml of the neutraliser toxicity validation. [symbol]
indicates data missing or illegible when filed

TEST 4
Assessment of the Efficacy of the Composition - Determined using
the European Standard Test Method EN 1500:1997

| | |
|---|---|
| Tests Carried Out By: | University of Huddersfield. School of Applied |
| | Sciences, Queensgate, Huddersfield HD1 3DH |
| Date: | March 2005 |
| Microbiological Tests | |
| Test Method | European Standard EN 1500:1997 |
| Test Procedures | Full details of all the test and control procedures |
| | used are given in the Test Method |
| Batch Tested | 17012005 |
| Temperature | 20° C. (±1° C.) |
| Contact Time Tested | 1 minute |
| Test Organism | Escherichia coli K12 10083 (NCIMB), National |
| | Collections of Industrial, Food and Marine |
| | Bacteria, Aberdeen. |
| Culture Medium | Tryptone Soya Agar, LabM |
| Incubation | Plates were incubated at 37° C. for 24-48 h |
| Counting procedure | Pour plate |
| Diluent | ¼ Strength Ringer's (LabM) |
| Neutralisers | The Composition, a neutraliser containing |
| | polysorbate 80, L-histidine, saponin and |
| | cysteine in diluent. |
| | Propan-2-ol 60% (v/v) reference hand rub a |
| | neutraliser containing polysorbate, lecithin, and |
| | L-histidine in diluent. |
| | Tests were carried out to verify that these |
| | neutralisers were satisfactory. (See Annex 1) |

Ethics committee approval was sought and granted for the application of the following test method.

### Test Method and Validation

EN 1500:1997 Chemical disinfectants and antiseptics—Hygienic handrub—Test method and requirements (phase 2/step 2). This European Standard specifies a method of test simulating practical conditions for establishing whether a product for hygienic handrub reduces the release of transient flora according to the requirements when rubbed onto artificially contaminated hands of volunteers.

The method involves applying live test organisms (Escherichia coli K12 10083NCIMB) to the hands, then recovering the test organism in order to obtain a baseline count. The test or reference disinfectant product is then applied to the hands before once again recovering any surviving test organisms in sampling broth containing neutralisers to terminate the effect of any residual disinfectant. The organisms are enumerated, counts transposed to the Log₁₀ system and the difference between the numbers recovered from the test or reference, and baseline counts is established and statistically analysed for significance. The larger the difference between the two counts, the more effective the product. Each of the volunteers repeats the procedure for the reference and test product.

For the test product to conform to the standard, EN 1500:1997, the mean log reduction should not be significantly smaller (at 90% significance level) than that obtained when using the reference product.

### Method of Application:

Application of the test organism: Hands were prepared by washing for 1 minute with soft soap to remove transients and dried thoroughly on paper towels (Soft soap, 200 g l⁻¹; Linseed oil 50 parts (by weight); Potassium hydroxide 9.5 parts; Ethanol 7parts in distilled water, autoclave to sterilize). Hands were immersed to the mid-metacarpals for 5 s, fingers apart, in 2 l of cultured test organism, E. coli K12. containing between 2×10⁸ and 2×10⁹ cfu ml⁻¹. Hands were air dried for 3 minutes were upon the test procedure was commenced, either reference handrub procedure (R) or test product (P) as outlined below.

Reference Product (R): 60% (w/v) Propan-2-ol

Reference Handrub Procedure (R): Three mls of the reference product (propan-2-ol) was poured into the cupped dry hands and rubbed vigorously into the skin for 30 seconds up to the wrists in accordance with the standard handrub procedure shown in FIG. 1. This ensured total coverage of the hands. The technique comprises of five strokes backwards and forwards, palm to palm, right palm over left dorsum and left palm over right dorsum, palm to palm with fingers interlaced, back of fingers to opposing palms with fingers interlocked, rotational rubbing of right thumb clasped in left palm and left thumb clasped in right palm, rotational rubbing with clasped fingers, of right hand in palm of left hand and clasped fingers of left hand in palm of right hand. The procedure was repeated with a further 3 ml of the reference product, to give a total rubbing time of 60 seconds. The reference procedure was completed by a 5 second rinse of the fingers under running tap water. Excess water was shaken off. Sampling commenced immediately.

### Test Product (P): The Composition, Applied as 3 ml Aliquots for 30 Seconds Repeated Once.

The test product was applied using the same rubbing technique as described for the reference product (R). The procedure was completed by a 5 second rinse of the fingers under running tap water. Excess water was shaken off, and sampling commenced immediately.

### Results

TABLE 9
Reference handrub procedure propan-2-ol 60% (v/v)

| | |
|---|---|
| Preparation | propan-2-ol 60% (v/v) |
| Application | rub-in 3 ml/30 s, repeat once |
| Date of experiment | 17-Mar-05 |
| Test organism | E. coli K12 NCIMB 10083 |
| Suspension | 2.14 × 10⁹ cfu ml⁻¹ |

| | Hand | Number of CFU per plate from dilution 10^{x} | | | | | | | | | |
|---|---|---|---|---|---|---|---|---|---|---|---|
| Subject | left or | Prevalues | | | | Postvalues | | | | | |
| No. | right | 10⁻⁴ | 10⁻⁴ | 10⁻⁵ | 10⁻⁵ | 10⁰ | 10⁰ | 10⁻¹ | 10⁻¹ | 10⁻² | 10⁻² |
| 1 | l | | | 61 | 50 | 48 | 64 | | | | |
| | r | 212 | 200 | 19 | 22 | 106 | 92 | | | | |
| 2 | l | 63 | 58 | | | | | | | 110 | 121 |
| | r | 151 | 165 | 15 | 15 | | | | | 31 | 41 |
| 3 | l | | | 367 | 397 | | | | | 92 | 94 |
| | r | | | 193 | 168 | | | | | 88 | 126 |
| 4 | l | | | 83 | 64 | | | 204 | 176 | | |
| | r | | | 116 | 111 | | | | | 42 | 36 |
| 5 | l | | | 290 | 307 | | | 238 | 260 | | |
| | r | | | 724 | 762 | | | | | 44 | 42 |
| 6 | l | | | 125 | 119 | | | 99 | 90 | | |
| | r | | | 293 | 281 | | | 129 | 131 | | |
| 7 | l | | | 95 | 88 | | | 188 | 224 | | |
| | r | | | 73 | 66 | | | 97 | 90 | | |
| 8 | l | | | 207 | 185 | | | | | 136 | 140 |
| | r | | | 97 | 85 | | | | | 121 | 115 |
| 9 | l | | | 138 | 131 | | | | | 78 | 79 |
| | r | | | 94 | 92 | | | | | 85 | 85 |
| 10 | l | | | 149 | 150 | | | | | 115 | 117 |
| | r | | | 113 | 102 | | | | | | |
| 11 | l | | | 160 | 159 | | | | | 112 | 126 |
| | r | | | 175 | 163 | | | | | 58 | 60 |
| 12 | l | | | 128 | 124 | | | | | 233 | 240 |
| | r | | | 147 | 156 | | | | | 215 | 207 |
| 13 | l | | | 358 | 332 | | | | | 46 | 41 |
| | r | | | 412 | 346 | | | | | 105 | 100 |
| 14 | l | | | 23 | 21 | 160 | 170 | | | | |
| | r | | | 21 | 30 | | | 260 | 252 | | |
| 15 | l | | | 322 | 266 | | | 148 | 122 | | |
| | r | | | 510 | 482 | | | 214 | 260 | | |

TABLE 10
Handrub procedure with the test
product (the Composition)

| | Preparation | | | Exemplary composition | | | | | | | |
|---|---|---|---|---|---|---|---|---|---|---|---|
| | Application | | | rub-in 3 ml/30 s, repeat once | | | | | | | |
| | Date of experiment | | | 17-Mar-05 | | | | | | | |
| | Test organism | | | E. coli K12 NCIMB 10083 | | | | | | | |
| | Suspension | | | 2.14 × 10⁹ cfu ml⁻¹ | | | | | | | |
| | | Number of CFU per plate from dilution 10^{x} | | | | | | | | | |
| Subject | Hand | Prevalues | | | | Postvalues | | | | | |
| No. | left or right | 10⁻⁴ | 10⁻⁴ | 10⁻⁵ | 10⁻⁵ | 10⁰ | 10⁰ | 10⁻¹ | 10⁻¹ | 10⁻² | 10⁻² |
| 1 | l | 180 | 197 | | | | | 318 | 304 | | |
| | r | 103 | 128 | | | | | | | 45 | 35 |
| 2 | l | | | 110 | 74 | | | 312 | 294 | | |
| | r | | | 37 | 39 | | | | | 34 | 35 |
| 3 | l | | | 166 | 171 | | | 334 | 298 | | |
| | r | | | 77 | 78 | | | 306 | 308 | | |
| 4 | l | 84 | 105 | | | | | 144 | 146 | | |
| | r | | | 25 | 24 | | | 130 | 124 | | |
| 5 | l | | | 270 | 264 | | | 316 | 314 | | |
| | r | | | 222 | 226 | | | 240 | 282 | | |
| 6 | l | | | 59 | 53 | | | 152 | 168 | | |
| | r | | | 63 | 59 | | | 180 | 156 | | |
| 7 | l | | | 44 | 35 | | | 192 | 182 | | |
| | r | | | 36 | 41 | | | 66 | 90 | | |
| 8 | l | | | 23 | 30 | | | | | 77 | 75 |
| | r | | | 27 | 35 | | | 266 | 318 | | |
| 9 | l | | | 63 | 91 | | | 154 | 138 | | |
| | r | | | 27 | 25 | | | 188 | 192 | | |
| 10 | l | | | 95 | 98 | | | | | 93 | 98 |
| | r | | | 41 | 47 | | | | | 91 | 89 |
| 11 | l | | | 88 | 91 | | | 102 | 104 | | |
| | r | | | 37 | 46 | | | 200 | 208 | | |
| 12 | l | | | 28 | 33 | | | 110 | 112 | | |
| | r | | | 25 | 24 | | | 104 | 102 | | |
| 13 | l | | | 304 | 292 | | | | | 63 | 64 |
| | r | | | 342 | 318 | | | | | 52 | 52 |
| 14 | l | | | 132 | 136 | | | 264 | 268 | | |
| | r | | | 176 | 137 | | | 64 | 90 | | |
| 15 | l | | | 240 | 248 | | | 74 | 90 | | |
| | r | | | 276 | 290 | | | 118 | 130 | | |

TABLE 11
Computed log₁₀ values (mean of left and right hand) and log₁₀ reduction
factors of the experimental results (Table 9 and Table 10)

| | Reference | | | Product | | |
|---|---|---|---|---|---|---|
| | procedure propan-2-ol 60% v/v (R) | | | test product (P) (the Composition) | | |
| Subject | log x | log y | log z | log x | log y | log z |
| 1 | 6.580354661 | 1.889302 | 4.691053 | 6.181844 | 3.55206 | 2.629784 |
| 2 | 6.038421446 | 3.879239 | 2.1591822 | 6.812913 | 3.511215 | 3.301699 |
| 3 | 7.449092531 | 4.000868 | 3.4482248 | 7.089905 | 3.493458 | 3.596447 |
| 4 | 6.970811611 | 3.460522 | 3.5102896 | 6.22981 | 3.133539 | 3.096271 |
| 5 | 7.716629279 | 3.5302 | 4.1864296 | 7.390051 | 3.459392 | 3.930659 |
| 6 | 7.310693312 | 3.050186 | 4.260507 | 6.767156 | 3.214844 | 3.552312 |
| 7 | 6.90579588 | 3.175367 | 3.730429 | 6.591065 | 3.214844 | 3.376221 |
| 8 | 7.156851901 | 4.10738 | 3.0494723 | 6.458638 | 3.720159 | 2.738479 |
| 9 | 7.055951405 | 3.91169 | 3.1442612 | 6.711807 | 3.225309 | 3.486498 |
| 10 | 7.108903128 | 3.827369 | 3.2815339 | 6.846646 | 3.967548 | 2.879098 |
| 11 | 7.215505378 | 3.948413 | 3.2670924 | 6.816241 | 3.186108 | 3.630133 |
| 12 | 7.142232992 | 4.349763 | 2.7924699 | 6.439333 | 3.029384 | 3.409949 |
| 13 | 7.558708571 | 3.86362 | 3.6950884 | 7.49693 | 3.762491 | 3.734439 |
| 14 | 6.375663614 | 3.134337 | 3.2413271 | 7.162116 | 3.234264 | 3.927852 |
| 15 | 7.596597096 | 3.269513 | 4.3270842 | 7.420781 | 3.012837 | 4.407943 |
| mean | 7.078814187 | 3.559851 | 3.518963 | 6.827682 | 3.381163 | 3.446519 |
| s | 0.462385412 | 0.605528 | 0.6567008 | 0.41678 | 0.283976 | 0.476787 |
| N | 15 | 15 | 15 | 15 | 15 | 15 |

| | |
|---|---|
| x - log₁₀ pre values | mean value from left and right hands |
| y - log₁₀ post values | mean value from left and right hands |
| x - x-y log₁₀ reduction | mean value |
| s - Standard deviation | |
| n - Sample size | |

### Statistical Analysis

TABLE 12
Statistical comparison of values as obtained with R (control) and P
(product)

| | | | | Rank of difference | |
|---|---|---|---|---|---|
| | log RF derived from | | Difference | without | |
| Subject | R | P | R − P | sign | with sign |
| 1 | 4.691053 | 2.629784 | 2.0612689 | 15 | 15 |
| 2 | 2.159182 | 3.301699 | −1.142516 | 14 | −14 |
| 3 | 3.448225 | 3.596447 | −0.148222 | 3 | −3 |
| 4 | 3.51029 | 3.096271 | 0.4140187 | 10 | 10 |
| 5 | 4.18643 | 3.930659 | 0.2557706 | 4 | 4 |
| 6 | 4.260507 | 3.552312 | 0.7081949 | 13 | 13 |
| 7 | 3.730429 | 3.376221 | 0.3542083 | 7 | 7 |
| 8 | 3.049472 | 2.738479 | 0.3109938 | 5 | 5 |
| 9 | 3.144261 | 3.486498 | −0.342237 | 6 | −6 |
| 10 | 3.281534 | 2.879098 | 0.4024355 | 9 | 9 |
| 11 | 3.267092 | 3.630133 | −0.363041 | 8 | −8 |
| 12 | 2.79247 | 3.409949 | −0.617479 | 11 | −11 |
| 13 | 3.695088 | 3.734439 | −0.03935 | 1 | −1 |
| 14 | 3.241327 | 3.927856 | −0.686525 | 12 | −12 |
| 15 | 4.327084 | 4.407943 | −0.080859 | 2 | −2 |

RF: reduction factor z
Sum of ranks (+): 63
Sum of ranks (−): 57

When the smaller sum of the ranks (here 57) is compared with the tabulated values from the Wilcoxon table (Table 13) at a significance level of 0.1 i.e. 90% (value 36), the sum of ranks is not smaller than the tabulated value. The composition rubbed in for 30 seconds (repeated once) is therefore not significantly different in efficacy (either more or less) than the reference product. The composition meets the efficacy requirements of EN 1500:1997

TABLE 13
Wilcoxons matched-pairs signed-rank test critical values of the
lower of both sums of ranks with (+) or (−) sign at different
significance levels

| Number of pairs with difference | | | |
|---|---|---|---|
| not equal to 0 | Level of significance | | |
| n | 0.1 (90%) | 0.05 (95%) | 0.01 (99%) |
| 12 | 12 | 17 | 9 |
| 13 | 26 | 21 | 12 |
| 14 | 31 | 25 | 15 |
| 15 | 36 | 30 | 19 |

### Conclusion:

According to EN 1500:1997, the Composition when applied in two 3 ml aliquots and rubbed into the hands for 60 seconds in total, is not significantly more or less effective at a 90% confidence level than the reference product propan-2-ol 60% (w/v), which is applied in two 3 ml aliquots and rubbed into the hands for 60 seconds in total. The Composition when applied in the manner described therefore meet the requirement stipulated in EN 1500:1997 i.e. the mean reduction of the release of test organisms achieved by the Composition is not significantly smaller than that achieved by the reference product (propan-2-ol 60% w/v) and therefore passes the European Standard EN 1500:1997 for a hygienic hand rub.

Standard Handrub Procedure

Four appropriate volume of handrub product into the cupped dry hands and rub hands 30 s-60 s in accordance with the standard handrub shown below to ensure total coverage of the hands. The action in each step is repeated five times before proceeding to the next step. After concluding step 6, recommence the series of steps as appropriate to complete the washing time.
Adapted from EN 1500:1997 Chemical disinfectants and antiseptics—hygienic handrub test method and requirements (phase 2/step 2)

### Method Validation

A1. Validation of Non-Toxicity of the Neutralisation Medium (Control)

To 9 ml of neutralisation medium 1 ml of bacterial test suspension diluted to 1×10³ to 3×10³ is added, mixed and left in the water bath at 20° C.±1° C. for a contact time of 1 min±5 s. At the end of the contact time 1 ml samples are taken in duplicate and pour plates prepared, after incubation at 37° C. for 48 h. The average plate count N′ of the neutralisation medium is determined.

A2. Validation of the Inactivation by the Dilution Neutralisation Method (Test)

To 1 ml of the bacterial diluent 9 ml of the handrub product is added, mixed and left in a water bath at 20° C.±1° C. for 5 min±10 s. 1 ml of the mixture is then transferred to 8 ml of neutralising medium, maintained at 20° C.±1° C. and left for 5 min±10 s. 1 ml of bacterial test suspension diluted to 1×10³ to 3×10³ is added, mixed and left for a contact time of 1 min±5 s. At the end of the contact time 1 ml samples are taken, in duplicate and pour plates prepared, after incubation at 37° C. for 48 h. The average plate count n′ of the dilution neutralisation method is determined.

TABLE 14
Validation of dilution-neutralisation method

| | Bacterial test | | |
|---|---|---|---|
| | suspension | | |
| | (cfu ml⁻¹) | Validation of | |
| | Escherichia | neutralisation | |
| Neutraliser | coli | A1. Control | A2. Test |
| polysorbate 80, L- | 211, 205 | 200, 199 | 193, 185 |
| histidine, saponin and | (N = 208) | (N′ = 199.5) | (n′ = 189) |
| cysteine - the | | | |
| Composition (P) | | | |
| polysorbate, lecithin, and | 211, 205 | 203, 201 | 189, 180 |
| L-histidine - Propan-2-ol | (N = 208) | (N′ = 202) | (n′ = 184.5) |
| (R) | | | |

### Results

For the test organism Escherichia coli K12:

N and N′ are between 100 and 300 cfu

N′ is greater than 0.5 times N

n′ is greater than 0.5 times N′

The neutralisation is validated with the neutralisation mediums tested.

### User Opinion

Although European test methods such as EN1500:1997 exclude user acceptability studies it is widely acknowledged that user acceptability is essential to ensure hand washing/disinfection compliance. On conclusion of the test procedure the participants were invited to wash/disinfect their hands using Purell alcohol gel. The results of an opinion poll of the 1.5 participants are shown in Table 15.

| | | | | | The | | | |
|---|---|---|---|---|---|---|---|---|
| | Soft soap | | Propan-2-ol | | Composition | | Purell | |
| Smell | −13 | | −9 | | 13 | | 5 | |
| Feel | −3 | | −5 | | 13 | | −13 | |
| Overall | −16 | (4) | −14 | (3) | 26 | (1) | −10 | (2) |
| preference | | | | | | | | |

Score:
Good = +1
No opinion = 0
Poor = −1
No. of participants = 15
(1-4) = order of preference

What is clear is that the Composition and the Purell product were all far more popular than the standard un-medicated soft soap or the reference control formulations, propan-2-ol 60%. A favourable majority of the participants (13) found the feel and smell of the Composition acceptable/good. What is interesting is that the majority of the participants (13) did not like the feel of the Purell product, reporting it as feeling sticky.

### Summary

Cosmetic or user acceptability is an essential issue in the selection of hand disinfection and hand rubs. If the product is unpleasant it will not be used and compliance with national good practice hand disinfection guidelines will be unlikely. User opinion was gained from all 15 participants in this study on the smell and feel of the reference and test products and a current in-use hand gel. The Composition was reasonably popular whereas the reference standards, propan-2-ol 60% and the un-medicated soft soap were not. From this study it is difficult to make a direct comparison between the Purell hand rub and the Composition, however initial reaction would appear to favour the use of the Composition over the Purell hand gel.

### Opinion

During the research supporting these results we encountered some difficulty identifying an effective neutraliser for alcohol based products (active ingredients of 70%). The published literature suggests the use of universal neutralisers. However, we failed to find an effective chemical neutraliser, using the membrane filtration method where appropriate. This problem of neutralising a product which is effectively 70% active does not seem to have been encountered or addressed within the published literature within this field of microbiology. Potentially this may lead to the questioning of results on high activity products, predominantly those that contain alcohol, where neutralisation of the product has been via a chemical neutraliser.

TEST 5
Report on the efficacy of the Composition against hepatitis B virus

| | |
|---|---|
| Tests Carried Out By: | Micropathology Ltd, University of Warwick |
| | Science Park, Barclays Venture Centre, Sir |
| | William Lyons Road, Coventry CV4 7EZ |
| Date: | Report prepared 24/01/06 |

### Hepatitis B Virus Antigen Inactivation

### Introduction

Despite the availability of a safe and effective vaccine, hepatitis B remains a globally important disease. The major routes of transmission of hepatitis B virus (HBV) are parenteral and infectivity appears to be especially related to blood, however hepatitis B is not spread exclusively by blood and blood products. It has been observed that under certain circumstances the virus is infective by mouth, that it is endemic in closed institutions and institutions for the mentally handicapped, that it is more prevalent in adults in urban communities and in poor socioeconomic conditions. There is much evidence for the transmission of hepatitis B by intimate contact and by the sexual route. HBV has been found in various body fluids, such as saliva, menstrual and vaginal discharges, seminal fluid, breast milk, and serous exudates, and these have been implicated as vehicles of transmission of infection. It is not surprising therefore that contact associated hepatitis B is of major importance. Effective disinfection in institutional settings is therefore vital in preventing the spread of this highly infectious virus.

Indirect methods for measuring disinfectant activities against HBV have been developed since the virus cannot be propagated in cell culture. The most favoured method relies on the destruction of HBsAg, the surface antigen of HBV, (Destruction of the antigenicity and effect on the immunochemical reactivity of antigens of the hepatitis B virus (HBsAg, HBcAg and HBeAg) by disinfectants—a test model, Frosner, Jentsch and Uthemann Zbl. Bakt. Hyg., I Abt. Orig. B 176; 1, 1982). This method is recommended by the German Association for the Control of Viral Diseases rather than methods such as the demonstration of destruction of HBV DNA polymerase or the MADT (Morphological alteration and disintegration test). It is favoured for the following reasons:
I HBsAg is the virus receptor which allows selective infection of liver cells. Destruction of HBsAg should thus result in the loss of viral infectivity.
II Measurement of the destruction of virus DNA polymerase is not a sufficiently sensitive assay since sera that are DNA polymerase negative can also be HBV positive and infectious.
   III The antigen inactivation method usually makes greater demands on the concentration or contact time of the biocide than the alternative indirect methods.

Destruction of HBsAg is demonstrated in this test by the loss of immunological reactivity of a high titre HBsAg positive serum following exposure to the biocide as measured by an enzyme immuno-assay (EIA). A disinfectant is only assumed to be effective against HBV in the antigen inactivation test if there is complete destruction of the antigenicity of the HBsAg.

### Protocol

The Composition was tested using the antigen inactivation test after discussion with the supplier. The product was used as supplied without dilution.

The source of the HBsAg for this test was a patient with well-documented chronic hepatitis B. The serum had high titres of HBsAg and HBV DNA, and was HBeAg positive. A relatively small volume of this serum sample was used in this challenge to reflect the likely use of this product as a general disinfectant.

2.5 μl aliquots of the serum sample were treated in a suspension test without the addition of a high protein load by adding,
a. 997.5 μl of the Composition, or
b. 997.5 μl of distilled water

These treatments were performed at room temperature (˜21° C.) for contact times of 5 minutes and 15 minutes (15 minutes only for the water treatment).

Following the exposure, dilutions in calf serum were made of the biocide/serum mix giving 1:10, 1:100 and 1:1000 dilutions.

These dilutions were tested for the presence of HBsAg using a commercial enzyme immuno-assay according to the manufacturers instructions and including the manufacturers controls.

### Results

The results are expressed as optical density (OD) readings.
Assay negative controls OD=0.033, 0.020, 0.019
Assay positive control OD=2.346
Assay cut-off calculated according to the kit manufacturers formula OD=0.054

The Composition

| Dilution | 5 minutes | 15 minutes | Water |
|---|---|---|---|
| 1:10 | 0.049 | 0.042 | 0.388 |
| 1:100 | 0.028 | 0.030 | 0.068 |
| 1:1000 | 0.022 | 0.021 | 0.032 |

OD readings in bold type are considered positive for the detection of HBsAg according to the calculated assay cut-off.

### Comment

After 5 minutes contact time to the Composition, HBsAg was undetectable in the serum sample and it was therefore successful in this indirect estimation of its activity against HBV.

As Micropathology Ltd has no control over the usage of this material; this testing does not constitute an endorsement of this product by Micropathology Ltd in any application. Whilst Micropathology Ltd has tested this material in the manner indicated; the Company specifically excludes any reference to its name in any literature as promotional material related to any product so cited.

TEST 6
Report on the efficacy of the Composition against hepatitis C
virus measured using destruction of viral genome as a marker

| | |
|---|---|
| Tests Carried Out By: | Micropathology Ltd, University of Warwick |
| | Science Park, Barclays Venture Centre, Sir |
| | William Lyons Road, Coventry CV4 7EZ |
| Date: | Report prepared 30/01/06 |

### Hepatitis C Virus RNA Degradation

### Introduction

Infection with hepatitis C virus (HCV) occurs to varying degrees around the world. Its prevalence in western Europe is estimated by the World Health Organisation at being 1-2.4% of the general population. In certain population groups however, such as those with a current or past history of intra-venous drug use, the incidence of infection is much higher.

HCV can cause chronic disease for which there is currently no effective treatment and vaccination has yet to be developed. The virus may persist at a high concentration for many years in the bloodstream of infected individuals and has also been detected in other types of body fluids. Therefore its control is of importance in any situation where people are exposed to spillages of blood and possibly other body fluids.

Difficulties exist in measuring the effectiveness of disinfectants against the virus. HCV cannot be grown in the laboratory and the only animal model is the chimpanzee. Viral nucleic acid is usually readily detectable in the serum of chronically infected patients, often at high titres. Therefore the only practicable source of virus-specific molecules on which to base an indirect method for measuring the effectiveness of disinfectants against the virus is the blood of viraemic patients. This protocol uses an assay for measuring the concentration of the viral nucleic acid (which in the case of HCV is RNA) in serum following exposure of the sample to the disinfectant, and to distilled water as control. The loss of detectable viral RNA is used as a marker of virus ‘killing’. The assay is likely to underestimate the effectiveness of disinfectants against HCV because the RNA molecule detected is relatively resistant to chemical degradation; it is, however, essential for infectivity and so its disappearance following treatment is a reliable indication of virus inactivation.

### Protocol

The source of the HCV RNA for this test was a patient with well-documented chronic hepatitis C. The serum had a high titre (>106 HCV RNA copies/ml) of HCV RNA, and was HCV antibody positive. 2.5 μl aliquots of the serum sample were treated in a suspension test without the addition of a high protein load by adding,
a. 997.5 μl of the Composition, or
b. 997.5 μl of distilled water

These treatments were performed at room temperature (˜21° C.) for contact times of 5 minutes and 15 minutes (15 minutes only for the water treatment). Following this extraction procedure (High Pure Viral Nucleic Acid extraction kit; Roche; according to the manufacturers instructions) was used to isolate viral RNA from the solution. Residual disinfectant was removed at this stage.

The concentration of remaining detectable viral RNA was measured using a very sensitive quantitative assay, the results of which are expressed as copies of RNA detected per millilitre.

The Composition

| 5 minutes | 15 minutes | Water treatment |
|---|---|---|
| NOT detected | NOT detected | 5,825 HCV RNA |
| (<100 HCV RNA | (<100 HCV RNA | copies/ml |
| copies/ml) | copies/ml) | |

### Comment

To be considered successful in this protocol a disinfectant must be able to reduce the concentration of HCV RNA to an undetectable level, which, with the sensitivity of the assay used, is less than 100 copies/ml. After 5 minutes contact time to the Composition, HCV RNA was not detectable in the serum sample and the Composition was therefore successful in this indirect estimation of its activity against HCV.

### Test 7

### A Study to Assess the Cutaneous Irritancy of a Single Occlusive Application of A Disinfectant Wipe

### Summary

A disinfectant wipe impregnated with the Composition was tested to determine its skin irritancy following a single 1 hour occlusive application in a test panel of 25 normal volunteer subjects. The design of the study was that of a ‘single occlusive application’ to assess cutaneous irritation. In such a design the material was applied under occlusion to the test site for 60 minutes with assessments at 10 minutes after patch removal and again at 24 and 48 hours. The disinfectant wipe was applied under occlusion using Tegaderm™ dressings.

The prime marker of cutaneous irritancy was considered to be erythema, which was graded using a 0-6 ranking scale. In this scale a grade 2 reaction (moderate, uniform erythema) was considered a noteworthy indication of cutaneous irritancy.

There were no grade 1 or grade 2 or higher reactions to the wipe recorded at either the 60 minute, 24 hour or 48 hour assessments. This result indicates that wipes impregnated with the Composition were well tolerated under the conditions of this test.

### Study Dates:

Start of study—Jan. 24, 2006
End of study—Jan. 26, 2006

### Introduction

This study was designed to assess the skin irritancy of a disinfectant wipe after a single 1 hour occlusive application to the skin of 25 normal volunteer subjects. The study design was that of a single occlusive application to assess cutaneous irritation. The test material was applied under occlusion to the test site for 60 minutes with assessments at 10 minutes after patch removal and again at 24 and 48 hours.

Regulatory Guidelines

No formal claim of GCP compliance was required for this study; however the practices and procedures adopted during the conduct of this study were consistent with the principles of ICH, GCP. All routine activities conducted during the course of the study were performed in accordance with Cutest Systems Ltd Standard Operating Procedures. In addition this study was designed to comply with the Guidelines for Medical Experiments in non-patient human volunteers that were initially published in the United Kingdom by the Association of the British Pharmaceutical Industry (ABPI) in March 1988 and further amended in May 1990.

### The Study

### Test Panel

A total of 25 male and female subjects were recruited from the volunteer test panel of Cutest. Details of the age and sex of the subjects is given in Table 16. The mean age of the 25 subjects tested was 42 years, age range 20-59 years. All subjects were normal volunteers who had previously been given a medical examination before joining the test panel. Each subject's medical history was also updated and recorded immediately prior to participation in this study by the study nurse.

In addition all subjects fulfilled the inclusion and exclusion criteria as detailed in the protocol, these were as follows:

### Inclusion Criteria

1. Subjects who are aged 18 years or over.
2. Subjects who are healthy with no significant concurrent illnesses.
3. Subjects who have signed the consent form after the nature of the study has been fully explained.

### Exclusion Criteria

1. Pregnant or lactating females at the start of the study or females of reproductive age who do not agree to take contraceptive measures to avoid becoming pregnant during the course of the study.
2. Subjects who have used any systemic or topical medication likely to interfere with the study, e.g. Systemic anti-inflammatory drugs.
3. Subjects who have used a new chemical entity (NEC) within the previous 56 days prior to study commencement.
4. Subjects who have taken part in a study involving the test sites during the previous 4 weeks (28 days).
5. Subjects with skin disease or a history of skin disease or allergy likely to interfere with the study.
6. Subjects with a history of, or evidence of alcohol or drug abuse.

### Ethical Considerations

Ethical approval for the study was obtained from the Cardiff Independent Research Ethics Review Committee (CIERC).

All subjects had the nature of the study explained to them aid were given written information concerning the study. All subjects gave their written, witnessed informed consent before starting the study. They were informed that they were able to withdraw from the study at any stage without obligation and without being required to state a reason.

### Materials

The study material was as follows:

| Product | Product Description |
|---|---|
| A | Wipes impregnated with the Composition |

### Application of Products

The test site for the study was the outer aspect of the upper arm.

The test site was not specially cleaned before application. The test site was inspected for any features such as moles or blemishes and the product applied in such a way as to avoid covering such features.

### Test Procedures

Each subject received the disinfectant wipe to the designated test site on the upper right or left arm. The application of the disinfectant wipe to the test sites was randomised (see Table 19).

The wipes were cut into 2×2 cm squares and applied to the skin using Tegaderm™ dressings (4.4 cm×4.4 cm, 1622 w, 3M). Applications were for 60 minutes under occlusion.

### Application and Assessment Schedule

The test material was applied under occlusion for a total of 60 minutes. The Tegaderm dressing/test material was removed and the site assessed using the following schedule:
Day 1. Apply material under occlusion for 60 minutes. Remove, wait 10 min. Assess sites (1 hour assessment).
Day 2. Assess sites (24 hour assessment).
Day 3. Assess sites (48 hour assessment). End of study.

The test site was assessed visually for erythema at 24 and 48 hours. Assessment was made using a 0-6 ranking scale as follows:

### Erythema Assessments

0=No reaction.
0.5=Slight, patchy erythema.
1=Slight uniform erythema.
2=Moderate, uniform erythema.
3=Strong erythema.
4=Strong erythema, spreading outside patch.
5=Strong erythema, spreading outside patch with either swelling or vesiculation.
6=Severe reaction with erosion.

This scale has been published.

Dykes P J & Marks R (1992). An evaluation of the irritancy potential of povidone iodine solutions: Comparison of subjective and objective assessment techniques. Clinical & Experimental Dermatology 17, 246-249.

### Clinical Scoring

If in addition to erythema other clinical signs of cutaneous irritation are observed the following letters will be appended to the numerical score as follows:
OE=Oedema
V=Vesiculation
S=Scaling
C=Cracking or crazing
SC=Scabbing
P=Papules
SO=Reaction spreading outside area of application
G=Glazing

If the volunteer reported burning or stinging at the test site this was recorded as
BS=Burning or Stinging.

Skin Tolerance

The skin tolerance of the test product was determined by the number of grade 2 (moderate, uniform erythema) or greater skin reactions recorded.

### Results

### Test Panel Attendance

All of the 25 subjects recruited for the study attended every assessment and were deemed to have completed the study.

### Presentation of the Results

The individual scores for the test material at the various assessment times are presented in Table 17. A summary is presented in Table 18.

### Comments

There were no grade 1 or grade 2 or higher reactions to the wipes recorded at either the 60 minute, 24 hour or 48 hour assessments.

This result indicates that die wipes were well tolerated under the conditions of this test.

TABLE 16
Details of Test Panel Subjects

| Subject | Test Panel | | |
|---|---|---|---|
| Number | Number | Age | Sex |
| 1 | 2019 | 56 | F |
| 2 | 0580 | 47 | F |
| 3 | 2465 | 24 | M |
| 4 | 0371 | 59 | F |
| 5 | 2442 | 59 | M |
| 6 | 2295 | 26 | F |
| 7 | 2276 | 40 | M |
| 8 | 1183 | 55 | F |
| 9 | 2300 | 42 | F |
| 10 | 2065 | 47 | F |
| 11 | 2194 | 35 | F |
| 12 | 2463 | 43 | F |
| 13 | 2454 | 20 | F |
| 14 | 1586 | 31 | M |
| 15 | 1712 | 49 | F |
| 16 | 0411 | 51 | F |
| 17 | 2443 | 35 | M |
| 18 | 1228 | 41 | F |
| 19 | 0518 | 54 | F |
| 20 | 2307 | 31 | F |
| 21 | 2468 | 45 | F |
| 22 | 1433 | 41 | F |
| 23 | 1042 | 37 | F |
| 24 | 1257 | 53 | F |
| 25 | 1050 | 43 | F |
| | Mean = | 42 | |
| | Upper age | 59 | |
| | Lower age | 20 | |

TABLE 17
Clinell Wipes - Erythema Scores

| | Day 1 | Day 2 | Day 3 |
|---|---|---|---|
| Subject | 60 mins | 24 hrs | 48 hrs |
| 1 | 0 | 0 | 0 |
| 2 | 0 | 0 | 0 |
| 3 | 0 | 0 | 0 |
| 4 | 0 | 0 | 0 |
| 5 | 0 | 0 | 0 |
| 6 | 0 | 0 | 0 |
| 7 | 0 | 0.5 | 0 |
| 8 | 0 | 0 | 0 |
| 9 | 0 | 0 | 0 |
| 10 | 0 | 0 | 0 |
| 11 | 0 | 0 | 0 |
| 12 | 0.5 | 0 | 0 |
| 13 | 0 | 0 | 0 |
| 14 | 0 | 0 | 0 |
| 15 | 0 | 0 | 0 |
| 16 | 0 | 0 | 0 |
| 17 | 0 | 0 | 0 |
| 18 | 0 | 0 | 0 |
| 19 | 0 | 0 | 0 |
| 20 | 0 | 0 | 0 |
| 21 | 0.5 | 0 | 0 |
| 22 | 0 | 0 | 0 |
| 23 | 0 | 0 | 0 |
| 24 | 0 | 0 | 0 |
| 25 | 0 | 0 | 0 |
| No. grade 0 | 23 | 24 | 25 |
| No. grade 0.5 | 2 | 1 | 0 |
| No. grade 1 | 0 | 0 | 0 |
| No. grade 2 | 0 | 0 | 0 |
| No. grade >2 | 0 | 0 | 0 |
| No. of NR | 0 | 0 | 0 |

TABLE 18
Summary of Results
Results are expressed as the number of subjects reacting with
each erythema grade

| | | | | |
|---|---|---|---|---|
| | | Day 1 | Day 2 | Day 3 |
| Product | Erythema Score | (60 mins) | (24 hours) | (48 Hours) |

Clinell Wipes (Marketed Product)

| | | | |
|---|---|---|---|
| Grade 0 | 23 | 24 | 25 |
| Grade 0.5 | 2 | 1 | 0 |
| Grade 1 | 0 | 0 | 0 |
| Grade 2 | 0 | 0 | 0 |
| NR = Not reapplied | 0 | 0 | 0 |

TABLE 19
Randomisation List

| Subject | Upper Arm |
|---|---|
| 1 | L |
| 2 | L |
| 3 | R |
| 4 | R |
| 5 | L |
| 6 | L |
| 7 | R |
| 8 | R |
| 9 | L |
| 10 | L |
| 11 | R |
| 12 | R |
| 13 | L |
| 14 | L |
| 15 | R |
| 16 | R |
| 17 | L |
| 18 | L |
| 19 | R |
| 20 | R |
| 21 | L |
| 22 | L |
| 23 | R |
| 24 | R |
| 25 | L |

### Test 8

### A Study to Determine the Virucidal Efficacy of a Test Article Against NIBRG-14 [H5N1] Influenza Virus

### Test Articles and Control Reference Articles

Test Articles

The test article was the Composition, which was assessed undiluted. In the virucidal assay, 9 volumes of test article were added to one volume of virus, yielding the final test concentration of 90% v/v.

### Control Reference Articles

The control(s) utilised in the toxicity assay are:
Cell only control: untreated cell. This was a negative control for tCPE (toxic cytopathic effect) and was also an indicator of cell quality. As standard infection media was used as a diluent, this was also the diluent control for the assay.

The controls utilised in the virucidal assay are:
Cell only control: cells not infected with virus. This is a negative control for vCPE (viral cytopathic effect) and was also an indicator of cell quality.
Diluent control: cells infected with virus that was pre-treated with standard infection media for the specified time. This was a negative control for the test articles and assessed any antiviral effects of the diluent.
Antiviral control: cells infected with virus that was pre-treated with citrate buffer at pH3.5. This was a positive control for comparison with the test article.

The cells of the controls used in each assay were incubated with standard cell infection media.

### Cells and Viruses

The cells used in this study were MDCK cells and were supplied from the Retroscreen Virology Ltd. cell bank.

The virus used in this study was Avian Influenza A NIBRG-14 [H5N1] virus. The NIBRG14 virus is a re-assortant virus between the A-PR8 and Influenza A/Vietnam viruses, created by NIBSC, UK.

The stock titre of avian Influenza NIBRG-14 virus (AL:870) was approximately 7.0 log10 TCID50/ml. Before use in the virucidal assay, the stock virus was diluted 1/10 (v/v) in MDCK infection media to obtain a titre of approximately 6.0 log10 TCID50/ml.

This virus was diluted a further 10-fold when it was added to the test article to form the reaction mixture. The total dilution of the virus, after termination, on addition to the plates was 1/1000 (v/v). To ensure consistency, the control virus was also diluted 1/1000 (v/v) before addition to the plate.

### Test Variables

The test articles were tested for virucidal activity by incubation with the virus for the following time point(s):
30 seconds
1 minute
5 minutes
10 minutes

### Study Time Lines

The study protocol was signed off on Feb. 20, 2006

The study was initiated on Feb. 23, 2006 and completed on Mar. 10, 2006.

### Preparation of MDCK Cells

MDCK cells (100 μl/well) were seeded onto 96-well plates at a density of 5×10⁴ cells/ml. The cells were incubated at 37° C. and 5% CO2 for ˜24 hours.

The plates were washed twice with PBS (100 μl/well) before use in either the cytotoxicity or virucidal assays.

### Cytotoxicity Assay

The test articles were diluted in the same way as in the virucidal assay (i.e. 40 μl of MDCK infection media, was added to 360 μl of the undiluted test article and then the total volume of 400 μl was added to 3.6 mls of MDCK infection media).

Each test article dilution was titrated, in triplicate following a 10-fold dilution series from neat (111 μl in the first well) across a 96-well plate of MDCK cells seeded at 5×10⁴ cells/ml. The plate was incubated at 37° C. and 5% CO2 for ˜1 hour.

After incubation, the cell monolayer was washed twice with PBS (100 μl/well) and fresh standard infection media (100 μl/well) was added. The plate was incubated at 37° C. and 5% CO2 for ˜4 hours.

After incubation, the plates were observed for tCPE (toxic cytopathic effect).

### Virucidal Assay

Virus (40 μl) was added to the test article (360 μl) and incubated at room temperature for the specified time points.

After incubation, the reaction was terminated by the addition of standard infection media (3.6 ml), which diluted the reaction 10-fold.

The terminated mixture was titrated, in quadruplicate, across a 96-well plate of MDCK cells following a 10-fold dilution series.

The cells were incubated for ˜1 hour at 37° C., 5% CO2. After incubation, the supernatant was discarded from the plates and the cell monolayer washed twice with PBS (100 μl) and fresh standard infection media (100 μl) added.

The cells were incubated for 3 days at 37° C. 5% CO2. After incubation the Hemagglutination assay (HA) was performed on the supernatant to determine the endpoint of the titrations.

The HA assay was carried out in accordance to the Retroscreen Virology Ltd. SOP VA018-02 (The Haemagglutination Assay).

### Cytotoxicity Assay

The cytotoxicity assay was used to determine if the test articles had any toxic effects on the MDCK cell line. The cells were observed for tCPE to determine any cytopathic effects caused by the test article. The tCPE observations are detailed in Table 20.

TABLE 20
tCPE observations of the MDCK cell monolayer after treatment with the
test articles and diluent control (MDCK Infection Media)

| Dilution | | | | | | |
|---|---|---|---|---|---|---|
| (10^{x}) | MDCK Infection Media | | | The Composition | | |
| 0 | — | — | — | T | T | T |
| −1 | — | — | — | T | T | T |
| −2 | — | — | — | — | — | — |
| −3 | — | — | — | — | — | — |
| −4 | — | — | — | — | — | — |
| −5 | — | — | — | — | — | — |
| −6 | — | — | — | — | — | — |
| Cell only | — | — | — | — | — | — |

Key:
T = positive for tCPE
— = negative for tCPE

### Virucidal Assay

The virucidal activity of the Composition against avian influenza NIBRG-14 [H5N1] was assessed for four different time points. The results of this, determined from the Haemaglutination assay are detailed in Table 21.

TABLE 21
Reduction in virus titre of avian Influenza NIBRG-14 [H5N1]
virus after treatment with the test article and positive
control article (citrate buffer at pH3.5)

| | | | Reduction in | |
|---|---|---|---|---|
| | Virus titre recovered | | virus titre | |
| | (log10 TCID50/ml) | | (−log10 | |
| Test reaction | Virus control | Test article | TCID50/ml) | (%) |
| Test article for 30 | 5.75 | ≧3.0^{A} | ≦2.75 | ≦99.82 |
| seconds | | | | |
| Test article for 1 | 5.75 | ≧2.75^{A} | ≦3.00 | ≦99.90 |
| minute | | | | |
| Test article for 5 | 6.00 | ≧3.5^{A} | ≦2.50 | ≦99.68 |
| minutes | | | | |
| Test article for 10 | 6.00 | ≧3.75^{A} | ≦2.25 | ≦99.44 |
| minutes | | | | |
| Positive control | 5.83 | 2.50 | 3.33 | 99.95 |
| article | | | | |

^{A}Toxicity observed but positive HA for virus obtained

### 9.3 pH Measurements

The pH of the Composition was measured undiluted and at the 90% (v/v) dilution in MDCK infection media. The results shown below are for reference only.

TABLE 22
pH of the Composition

Conc %
(v/v)

| | 100% | 90% |
|---|---|---|
| pH | 5.50 | 7.77 |

### Conclusion

The tCPE observations of the toxicity assay indicate that the test article had some toxic effects on the MDCK cell line. These effects were observed at the 10⁰ and 10⁻¹ dilution level in all three wells of the serial dilution.

The cytotoxic effects interfered with recovery of virus at the 10⁰ and 10⁻¹ dilution level in some wells of the test article serial titration during virucidal assessment. This prevented the accurate determination of the TCID50 of the test article incubated reactions.

The HA assay carried out during virucidal assessment was observed to recover virus at dilution levels below the level of toxicity, indicating the presence of virus at the levels of dilution below the observed cytopathic effect.

The HA results were used to determine a maximum level of virus reduction attributable to the test article; this was calculated at each of the different incubation time points. The observed cytotoxic effects were used to determine the minimum level of virus reduction attributable to the test article at each time point.

The Composition reduced the viral titre of Avian Influenza A NIBRG14 by a minimum 1.25−log10 TCID50/ml (94.38%) and a maximum of 2.75−log10TCID50/ml (99.82%) for the 30 second time point.

The Composition reduced the viral titre of Avian Influenza A NIBRG14 by a minimum 1.25−log10 TCID50/ml (94.38%) and a maximum of 3.00−log10 TCID50/ml (99.90%) for the 1 minute time point.

The Composition reduced the viral titre of Avian Influenza A NIBRG14 by a minimum 1.50−log10 TCID50/ml (96.84%) and a maximum of 2.50−log10 TCID50/ml (99.68%) for the 5 minute time point.

The Composition reduced the viral titre of Avian Influenza A NIBRG14 by a minimum 1.50−log10 TCID50/ml (96.84%) and a maximum of 2.25−log10 TCID50/ml (99.44%) for the 10 minute time point,

For all incubation lime points a≧1 log10 TCID50/ml reduction in virus titre of avian Influenza NIBRG-14 virus was observed. This is deemed a significant reduction (J. S. Oxford et al, 1994).

1-16. (canceled)

17. An antimicrobial composition comprising:
two or more cationic biocides; and
two or more biocides which are slower acting than the cationic biocides;
wherein each cationic biocide is independently either a quaternary ammonium compound at a concentration of at least 0.1% w/v or a biguanide compound.

18. The composition as claimed in claim 17 wherein the slower acting biocides are preservative biocides.

19. The composition as claimed in claim 17 wherein the concentration of each quaternary ammonium compound is at least 0.2% w/v.

20. The composition as claimed in claim 17 wherein the concentration of each quaternary ammonium compound is at least 0.3% w/v.

21. The composition as claimed in claim 17 wherein the concentration of each quaternary ammonium compound is independently from 0.33 to 0.57% w/v.

22. The composition as claimed in claim 17 wherein the concentration of each biguanide compound is independently from 0.075 to 0.125% w/v.

23. The composition as claimed in claim 17 wherein the slower acting biocides independently comprise an aryloxyethanol, an arylethanol compound, 2-bromo-2-nitropropan-1,3-diol, an amidine compound, 8-hydroxyquinoline, a benzyl alcohol, a phenothiazinne or a thiosemicarbazone.

24. The composition as claimed in claim 23 wherein the concentration of the aryloxyethanol is from 0.037 to 0.063% w/v.

25. The composition as claimed in claim 23 wherein the concentration of the arylethanol is from 0.015 to 0.025% w/v.

26. The composition as claimed in claim 17 further comprising ethanol.

27. The composition as claimed in claim 17 being substantially free of chlorinated phenol.

28. A material comprising:
a base material;
said base material being impregnated with two or more cationic biocides and two or more biocides which are slower acting than the cationic biocides, each cationic biocide being independently either a quaternary ammonium compound at a concentration of at least 0.1% w/v or a biguanide compound.

29. A dispenser comprising
a plurality of pieces of material, each piece of material being impregnated with two or more cationic biocides and two or more biocides which are slower acting than the cationic biocides, each cationic biocide being independently either a quaternary ammonium compound at a concentration of at least 0.1% w/v or a biguanide compound.

30. A method of cleaning human skin, an inanimate surface, or both, comprising:
using a composition having two or more cationic biocides and two or more biocides which are slower acting than the cationic biocides, each cationic biocide being independently either a quaternary ammonium compound at a concentration of at least 0.1% w/v or a biguanide compound.
